(19) United States
(12) Patent Application Publication
(10) Pub. No.: US 2007/0004822 A1
(43) Pub. Date: Jan. 4, 2007

(54) Water-based inks for inkjet printers

(76) Inventors: Hitoshi Inoue, Ibaraki (JP); Tomoya Yamamoto, Ibaraki (JP); Yukiko Tachibana, Ibaraki (JP); Takayuki Ookawa, Ibaraki (JP); Junko Morioka, Ibaraki (JP)

Correspondence Address: HARNESS, DICKEY & PIERCE, P.L.C., P.O. BOX 8910, RESTON, VA, 20195, US

(21) Appl. No.: 10/540,129

(22) PCT Filed: Oct. 18, 2004
(86) PCT No.: PCT/JP04/15755

§ 371 Date: Jun. 21, 2005

(30) Foreign Application Priority Data
Jul. 15, 2003 (JP) 2003-197235

(51) Int. Cl. C03C 17/00

(52) U.S. Cl. 523/160

(57) ABSTRACT

A water-based ink for inkjet printers contains at least a water-insoluble colorant, a block copolymer of a polyvinyl ether structure comprising at least one kind of hydrophilic segments and at least one kind of hydrophobic segments, water and an alkali. Each of the hydrophilic segments contains acidic groups. A content of the alkali is such that, when an infrared absorption intensity ascribable to ionic groups to be formed upon addition of an excess amount of the alkali to the block copolymer is supposed to be 100%, an infrared absorption intensity ascribable to ionic groups formed by dissociation of the acidic groups contained in the block copolymer becomes at least 80%, with a proviso that the content does not exceed twice as much as a smallest amount of the alkali that an infrared absorption intensity ascribable to ionic groups to be formed from the block copolymer becomes 100%.

### TECHNICAL FIELD

This invention relates to water-based inks for inkjet printers.

### BACKGROUND ART

Keeping in steps with the spreading of computers, inkjet printers are finding wide-spread utility. As inks for these inkjet printers, water-based inks are taking the position of a mainstream for their safety and the like. Among such water-based inks, water-based inks making use of water-soluble dyes are in most common use as they are excellent in color-developing ability. The water-based inks making use of water-soluble dyes are, however, accompanied by problems in that formed images are inferior in waterproofness because the dyes are soluble in water and the images undergo fast degradation with light or a gas such as ozone because the dyes are in molecular forms.

With a view to overcoming these problems, inks making use of insoluble colorants, such as pigments, that take the form of plural molecules joined together rather than molecular forms are under investigation. Images formed with these dispersion inks are superior in so-called image fastness such as waterproofness, light fastness and gas resistance to images formed with inks making use of water-soluble colorants. However, the dispersion inks are defective in storage stability, and tend to develop problems such as settling of the colorants, clogging at ink orifices, and reductions in the vividness of color hues due to the formation of colorants into larger particles through flocculation.

To permit stable dispersion of fine particles of insoluble colorants in aqueous media, there have been proposed inks making use of a block copolymer which contains segments readily adherent to these insoluble colorants and segments having high compatibility with the aqueous media (see JP-A-5-179183) and inks making use of graft copolymers (see JP-A-9-188732). Also proposed is a process which comprises dissolving a water-insoluble, oil-soluble dye in an organic solvent, mixing the resulting solution with a block copolymer and then adding water to the thus-obtained mixture to make the medium aqueous and hence to cause the oil-soluble dye to deposit as fine particles (JP-A-2002-97395).

These block copolymers contain acidic groups such as carboxyl groups in many instances to enhance the hydrophilicity of their hydrophilic groups. In an aqueous medium, these acidic groups dissociate into ionic groups so that hydrophilicity is exhibited. For this purpose, however, it is necessary to appropriately add an alkali such that the acidic groups are neutralized. If this neutralization is insufficient, the acidic groups do not dissociate sufficiently, and hence, hydrophilicity cannot be exhibited. The block copolymers with their colorants included therein cannot be stably dispersed in aqueous media. If an alkali conversely exists in excess beyond the neutral point, excessive ions are dissolved in the ink. These excessive ions weaken the electrostatic repulsive force of block copolymer particles in which the colorant is included, so that flocculation of dispersed particles is promoted.

It is, therefore, extremely important to control the degree of neutralization of acidic groups in a block copolymer in such a dispersion ink as described above. Under the current circumstances, however, no actual degree of neutralization is ascertainable, and the current practice is limited to such a method as adding an alkali in an amount calculated to be equivalent to acidic groups. However, the behavior of acidic groups in a polymer is complex, and neutralization does not necessarily proceed to a degree commensurate with the added amount of the alkali. It is, therefore, difficult to control the neutralization to any desired degree. As a result, there is a potential problem that the degree of neutralization of the polymer may fall out of an optimal range. When a dispersion is stored over a long term or is stored at a high temperature such as 50° C. or 60° C., the dispersion of the dispersed particles tends to become unstable. Even during its use in a conventional inkjet printer, a problem may be developed such as a deterioration of a color hue or clogging of an ejection orifice due to an increase in the particle size of dispersed particles.

With the foregoing circumstances in view, the present invention has as an object thereof the provision of a water-based ink for inkjet printers, which is of the colorant particle dispersion type, is excellent in storage stability and provides prints of high image fastness such as waterproofness, light fastness and gas resistance.

### DISCLOSURE OF THE INVENTION

The above-described object can be achieved by the present invention to be described hereinafter. Specifically, the present invention provides a water-based ink for inkjet printers, said water-based ink comprising at least a water-insoluble colorant, a block copolymer of a polyvinyl ether structure comprising at least one kind of hydrophilic segments each of which contains acidic groups and at least one kind of hydrophobic segments, water and an alkali, characterized in that a content of the alkali is such that, when the intensity of an infrared absorption (which may hereinafter be referred to as “infrared absorption intensity”) ascribable to ionic groups to be formed upon addition of an excess amount of the alkali to the block copolymer is supposed to be 100%, an infrared absorption intensity ascribable to ionic groups formed by dissociation of the acidic groups contained in the block copolymer becomes at least 80%, with a proviso that the content does not exceed twice as much as a smallest amount of the alkali that an infrared absorption intensity ascribable to ionic groups to be formed from the block copolymer becomes 100%.

In the present invention, it is preferred that the acidic groups contained in the block copolymer are carboxyl groups and that the colorant is a pigment or a water-insoluble dye.

In the present invention, the infrared absorption intensity ascribable to ionic groups formed by dissociation of the acidic groups contained in the block copolymer reflects the amount of the existing ionic groups, and serves as an effective index which indicates the degree of neutralization. Described specifically, when the alkali is added in an excess amount, the acidic groups in the block copolymer are completely neutralized and are dissociated substantially 100%. In the case of such an alkali content that the infrared absorption intensity ascribable to ionic groups is smaller than 80% when the infrared absorption intensity ascribable to ionic groups to be formed upon complete neutralization of acidic groups in the block copolymer is supposed to be 100%, on the other hand, there are still a number of acidic groups which have not dissociated yet. Accordingly, the block copolymer is provided with lower hydrophilicity so that the dispersion of fine particles of the colorant in the aqueous medium becomes unstable.

If the alkali is contained in an amount greater than twice as much as the smallest amount of the alkali required to achieve complete neutralization (100% neutralization), on the other hand, the alkali exists in excess of the amount equivalent to the ionic groups. In this case, the ionic strength in the solution increases so that the static repulsive force between particles, which the block copolymer forms with the colorant included therein, becomes weaker to facilitate mutual flocculation of dispersed particles.

When the content of the alkali is such that the infrared absorption intensity ascribable to groups neutralized to have ionic property is at least 80% of the infrared absorption intensity available upon complete neutralization (100% neutralization) and the content of the alkali is not more than twice as much as the smallest amount of the alkali required for complete neutralization, the dissociation of the acidic groups in the block copolymer is sufficient and extra ions formed by the alkali are not much, thereby making it possible to obtain a water-based ink excellent in dispersion stability.

### BRIEF DESCRIPTION OF THE DRAWINGS

FIG. 1 is a diagram showing percent increases of particle size when inks were stored at a high temperature.

### BEST MODES FOR CARRYING OUT THE INVENTION

The present invention will next be described in further detail based on preferred embodiments.

The block copolymer used in the present invention has such properties that it acts as a dispersant for stably dispersing fine particles of the colorant in the ink and subsequent to application of the ink to a recording medium such as paper, acts to fix the colorant on the recording medium. The block copolymer for use in the present invention comprises at least one kind of hydrophilic blocks (A,A′) and at least one kind of hydrophobic blocks (B,B′), and each of the hydrophilic blocks contains acidic groups.

No particular limitation is imposed on the arrangement of the individual blocks in the block copolymer. From the viewpoint of providing the colorant with improved dispersibility, however, the inclusion of hydrophilic blocks at ends of a polymer chain is preferred. Examples of the block arrangement include AB, ABA′ in which A and A′ can be either the same or different, AA′B, and BB′A in which B and B′ can be either the same or different. It is to be noted that A,A′,B,B′ are homopolymer or copolymer blocks.

Block copolymers which are preferred for use in the present invention are block copolymers, each of which contains hydrophilic blocks formed of a homopolymer or copolymer of a vinyl ether monomer and hydrophobic blocks formed of a homopolymer or copolymer of a vinyl ether monomer, and at least one of monomer(s) which make up the hydrophilic blocks contains one or more acidic groups.

Basic skeletons of these polymers may preferably contain recurring unit structures represented, for example, by the formula (1) to be described subsequently herein. It is, however, necessary that at least some of the below-described recurring units contain an acidic group such as a carboxyl group or a group capable of forming an acidic group such as a carboxyl group by hydrolysis or the like.
—(CH₂—CH(OR¹))— (1)

In the above-described formula (1), R¹ represents an aliphatic hydrocarbon group such as an alkyl, alkenyl, cycloalkyl or cycloalkenyl group; or an aromatic hydrocarbon group one or more of carbon atoms of which may be substituted by nitrogen atoms, such as a phenyl, pyridyl, benzyl, toluyl, xylyl, alkylphenyl, phenylalkyl, biphenyl or phenylpyridyl group. One or more of the hydrogen atoms on the aromatic ring may be substituted by hydrocarbon groups. The carbon number of R¹ may preferably range from 1 to 18.

R¹ can also be a group represented

by —(CH(R²)—CH(R³)—O)ₚ-R⁴ or —(CH₂)ₘ-(O)ₙ-R⁴. In this case, R² and R³ each independently represents a hydrogen atom or a methyl group, and R⁴ represents an aliphatic hydrocarbon group such as an alkyl, alkenyl, cycloalkyl or cycloalkenyl group, an aromatic hydrocarbon group one or more of carbon atoms of which may be substituted by nitrogen atoms, such as a phenyl, pyridyl, benzyl, toluyl, xylyl, alkylphenyl, phenylalkyl, biphenyl or phenylpyridyl group with one or more hydrogen atoms on the aromatic ring being optionally substituted by hydrocarbon groups, —CHO, —CH₂CHO—, —CO—CH═CH₂, —CO—C(CH₃)═CH₂, —CH₂—CH═CH₂, —CH₂—C(CH₃)═CH₂ or —CH₂COOR⁵. In each of these groups, one or more hydrogen atoms may be substituted by halogen atoms such as fluorine, chlorine or bromine atoms to chemically feasible extent. The carbon number of R⁴ may preferably range from 1 to 18. R⁵ represents a hydrogen atom or an alkyl group. Preferably, p can range from 1 to 18, m can range from 1 to 36, and n can be 0 or 1.

In R¹ and R⁴, examples of the alkyl and alkenyl groups can include methyl, ethyl, propyl, isopropyl, n-butyl, sec-butyl, t-butyl, pentyl, hexyl, heptyl, octyl, nonyl, decyl, dodecyl, tetradecyl, hexadecyl, octadecyl, and oleyl, and examples of the cycloalkyl and cycloalkenyl groups can include cyclopropyl, cyclobutyl, cyclopentyl, cyclohexyl and cyclooctyl.

Structures of monomers (I-a to I-o) and polymers (II-a to II-c) which include recurring units represented by the above-described formula (1) will be exemplified below, although polyvinyl ether structures usable in the present invention are not limited to them.

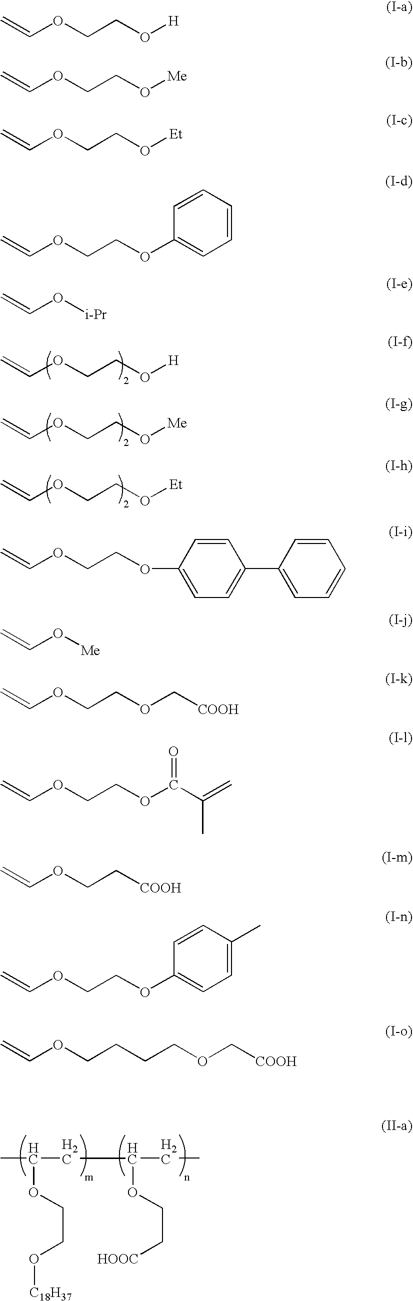

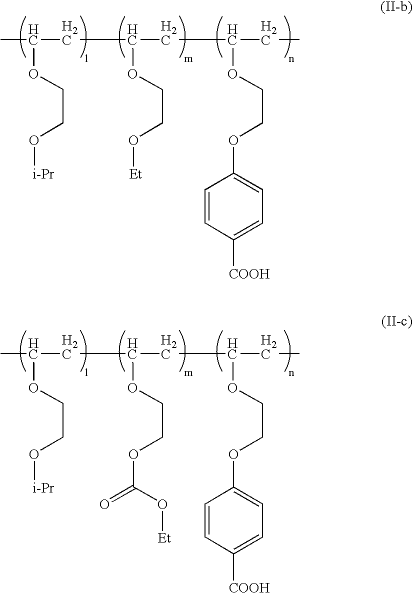

The preferred numbers of the respective recurring units in the polyvinyl ethers (i.e., m, n and 1 in the above-exemplified polymers (II-a) to (II-c)) may each independently range from 1 to 10,000. More preferably, their total (i.e., m+n+1 in the above-exemplified polymers (II-a) to (II-c)) may range from 10 to 20,000. The number average molecular weight may range preferably from 500 to 20,000,000, more preferably from 1,000 to 5,000,000, most preferably from 2,000 to 2,000,000. Further, these polyvinyl ethers may also be used in forms grafted on other polymers or in forms copolymerized with other recurring unit structures. In addition, each block may also be in the form of a copolymer of a vinyl ether monomer with another monomer.

No particular limitation is imposed on the process for the synthesis of the copolymer having the vinyl ether polymer blocks. Nonetheless, cation living polymerization proposed by Aoshima et al. (JP-A-11-322942 and JP-A-11-322866) or the like can be used suitably. The use of cation living polymerization makes it possible to synthesize various polymers, such as homopolymers, copolymers formed of two or more monomers, block polymers, graft polymers and graduation polymers, with their lengths (molecular weights) being precisely controlled. Further, various functional groups can also be introduced on side chains of these polyvinyl ethers.

In the present invention, these block copolymers are each used in the form that the acidic groups contained therein have been neutralized with an alkali. The amount of the alkali to be added is adjusted to give such an alkali content in the eventually resulting, water-based ink that, when the infrared absorption intensity ascribable to ionic groups to be formed upon complete neutralization of the block copolymer with an excess amount of the alkali is supposed to be 100%, the infrared absorption intensity ascribable to ionic groups formed by dissociation of acidic groups in the block copolymer becomes at least 80% and the content is not more than twice as much as the smallest amount of the alkali required to be added to make the infrared absorption intensity ascribable to the ionic groups become 100%. Usable examples of the alkali include sodium hydroxide, potassium hydroxide, lithium hydroxide and tetraalkylammonium hydroxide, with sodium hydroxide, potassium hydroxide and lithium hydroxide being preferred.

In the present invention, the block copolymer can preferably account for 0.001 to 40 wt. % of the total weight of the ink, with 0.01 to 20 wt. % being more preferred. A proportion of the block copolymer smaller than 0.001 wt. % leads to images reduced in abrasion resistance or the like, while a proportion of the block copolymer greater than 40 wt. % results in an ink having excessively high viscosity and induces a reduction in ejection stability such as clogging at nozzles.

Examples of the water-insoluble colorant for use in the present invention include conventionally-known water-insoluble colorants, for example, pigments, oil-soluble dyes, dispersion dyes and vat dyes; and water-soluble dyes, such as direct dyes, acid dyes, basic dyes and reactive dyes, which have been rendered insoluble in water by certain treatment.

(Black Pigments)

“Raven760Ultra”, “Raven1060Ultra”, “Raven1080Ultra”, “Raven1100Ultra”, “Raven1170”, “Raven1200”, “Raven1250”, “Raven1255”, “Raven1500”, “Raven2000”, “Raven2500Ultra”, “Raven3500”, “Raven5250”, “Raven5750”, “Raven7000”, “Raven5000UltraII”, “Raven1190UltraII” (trade names, products of Columbian Carbon Co.);

“Black Pearls L”, “MOGUL-L”, “Rega1400R”, “Rega1660R”, “Rega1330R”, “Monarch800”, “Monarch880”, “Monarch900”, “Monarch1000”, “Monarch1300”, “Monarch1400” (trade names, products of Cabot Corporation);

“Color Black FW1”, “Color Black FW2”, “Color Black FW200”, “Color Black 18”, “Color Black S160”, “Color Black S170”, “Special Black 4”, “Special Black 4A”, “Special Black 6”, “Special Black 550”, “Printex35”, “Printex45”, “Printex55”, “Printex85”, “Printex95”, “PrintexU”, “Printex140U”, “PrintexV”, “Printex140V” (trade names, products of Degussa AG);

“No. 25”, “No. 33”, “No. 40”, “No. 45”, “No. 47”, “No. 52”, “No. 900”, “No. 970”, “No. 2200B”, “No. 2300”, “No. 2400B”, “MCF-88”, “MA600”, “MA77”, “MA8”, “MA100”, “MA220”, “MA230” (trade names, products of Mitsubishi Chemical Corporation);

(Blue Pigments)

C.I. Pigment Blue (hereinafter referred to as “PB”) 1, C.I.PB-2, C.I.PB-3, C.I.PB-15, C.I.PB-15:2, C.I.PB-15:3, C.I.PB-15:4, C.I.PB-16, C.I.PB-22, C.I.PB-60, etc.;

(Red Pigments)

C.I. Pigment Red (hereinafter referred to as “PR”)-5, C.I.PR-7, C.I.PR-12, C.I.PR-48, C.I.PR-48:1, C.I.PR-57, C.I.PR-112, C.I.PR-122, C.I.PR-123, C.I.PR-146, C.I.PR-168, C.I.PR-184, C.I.PR-202, C.I.PR-207, etc.;

(Yellow Pigments)

C.I. Pigment Yellow (hereinafter referred to as “PY”)-12, C.I.PY-13, C.I.PY-14, C.I.PY-16, C.I.PY-17, C.I.PY-74, C.I.PY-83, C.I.PY-93, C.I.PY-95, C.I.PY-97, C.I.PY-98, C.I.PY-114, C.I.PY-128, C.I.PY-129, C.I.PY-151, C.I.PY-154, etc.;

(Oil-Soluble Yellow Pigments)

C.I. Solvent Yellow (hereinafter referred to as “SY”)-1, C.I.SY-2, C.I.SY-3, C.I.SY-13, C.I.SY-19, C.I.SY-21, C.I.SY-22, C.I.SY-29, C.I.SY-36, C.I.SY-37, C.I.SY-38, C.I.SY-39, C.I.SY-40, C.I.SY-43, C.I.SY-44, C.I.SY-45, C.I.SY-47, C.I.SY-62, C.I.SY-63, C.I.SY-71, C.I.SY-76, C.I.SY-81, C.I.SY-85, C.I.SY-86, etc.;

(Oil-Soluble Red Dyes)

C.I. Solvent Red (hereinafter referred to as “SR”)-35, C.I.SR-36, C.I.SR-37, C.I.SR-38, C.I.SR-39, C.I.SR-40, C.I.SR-58, C.I.SR-60, C.I.SR-65, C.I.SR-69, C.I.SR-81, C.I.SR-86, C.I.SR-89, C.I.SR-92, C.I.SR-97, C.I.SR-99, C.I.SR-100, C.I.SR-109, C.I.SR-118, C.I.SR-119, C.I.SR-122, etc.;

(Oil-Soluble Blue Dyes)

C.I. Solvent Blue (hereinafter referred to as “SB”)-14, C.I.SB-24, C.I.SB-26, C.I.SB-34, C.I.SB-37, C.I.SB-39, C.I.SB-42, C.I.SB-43, C.I.SB-44, C.I.SB-45, C.I.SB-48, C.I.SB-52, C.I.SB-53, C.I.SB-55, C.I.SB-59, C.I.SB-67, etc.;

(Oil-Soluble Black Dyes)

C.I. Solvent Black (hereinafter referred to as “SBk”)-5, C.I.SBk-8, C.I.SBk-14, C.I.SBk-17, C.I.SBk-19, C.I.SBk-20, C.I.SBk-22, C.I.SBk-24, C.I.SBk-26, C.I.SBk-28, C.I.SBk-43, etc.;

(Disperse Dyes)

C.I. Disperse Yellow-88, C.I. Disperse Red-349, C.I. Disperse Blue-160, C.I. Disperse Black-1, etc.;

(Vat Yellow Dyes)

C.I. Vat Yellow (hereinafter referred to as “VY”)-2, C.I.VY-4, C.I.VY-10, C.I.VY-20, C.I.VY-33, etc.;

(Vat Orange Dyes)

C.I. Vat Orange (hereinafter referred to as “VO”)-1, C.I.VO-2, C.I.VO-3, C.I. solubilized VO-3, C.I.VO-5, C.I.VO-7, C.I.VO-9, C.I.VO-13, C.I.VO-15, etc.;

(Vat Red Dyes)

C.I. Vat Red (hereinafter referred to as “VR”)-1, C.I.VR-2, C.I.VR-10, C.I.VR-13, C.I.VR-15, C.I.VR-16, C.I.VR-61, etc.;

(Vat Violet Dyes)

C.I. Vat Violet (hereinafter referred to as “VV”-1, C.I.VV-2, C.I.VV-9, C.I.VV-13, C.I.VV-21, etc.;

(Vat Blue Dyes)

C.I. Vat Blue (hereinafter referred to as “VB”)-1, C.I. solubilized VB-1, C.I.VB-3, C.I.VB-4, C.I.VB-5, C.I. solubilized VB-5, C.I.VB-6, C.I.VB-8, C.I.VB-12, C.I.VB-14, C.I.VB-18, C.I.VB-19, C.I.VB-20, C.I.VB-29, C.I.VB-35, C.I.VB-41, etc.;

(Vat Green Dyes)

C.I. Vat Green (hereinafter referred to as “VG”)-1, C.I.VG-2, C.I.VG-3, C.I.VG-4, C.I.VG-8, C.I.VG-9, etc.;

(Vat Brown Dyes)

C.I. Vat Brown (hereinafter referred to as “VBr”)-1, C.I.VBr-3, C.I.VBr-25, C.I.VBr-44, C.I.VBr-46, etc.;

(Vat Black Dyes)

C.I. Vat Black (hereinafter referred to as “VBk”)-1, C.I.VBk-8, C.I.VBk-9, C.I.VBk-13, C.I.VBk-14, C.I.VBk-20, C.I.VBk-25, C.I.VBk-27, C.I.VBk-29, C.I.VBk-36, C.I.VBk-56, C.I.VBk-57, C.I.VBk-59, C.I.VBk-60, etc.;

(Direct Black Dyes)

C.I. Direct Black (hereinafter referred to as “DBk”)-17, C.I.DBk-19, C.I.DBk-22, C.I.DBk-32, C.I.DBk-38, C.I.DBk-51, C.I.DBk-62, C.I.DBk-71, C.I.DBk-108, C.I.DBk-146, C.I.DBk-154, etc.;

(Direct Yellow Dyes)

C.I. Direct Yellow (hereinafter referred to as “DY”)-12, C.I.DY-24, C.I.DY-26, C.I.DY-44, C.I.DY-86, C.I.DY-87, C.I.DY-98, C.I.DY-100, C.I.DY-130, C.I.DY-142, etc.;

(Direct Red Dyes)

C.I. Direct Red (hereinafter referred to as “DR”)-1, C.I.DR-4, C.I.DR-13, C.I.DR-17, C.I.DR-23, C.I.DR-28, C.I.DR-31 , C.I.DR-62, C.I.DR-79, C.I.DR-81, C.I.DR-83, C.I.DR-89, C.I.DR-227, C.I.DR-240, C.I.DR-242, C.I.DR-243, etc.;

(Direct Blue Dyes)

C.I. Direct Blue (hereinafter referred to as “DB”)-6, C.I.DB-22, C.I.DB-25, C.I.DB-71, C.I.DB-78, C.I.DB-86, C.I.DB-90, C.I.DB-106, C.I.DB-199, etc.;

(Direct Orange Dyes)

C.I. Direct Orange (hereinafter referred to as “DO”)-34, C.I.DO-39, C.I.DO-44, C.I.DO-46, C.I.DO-60, etc.;

(Direct Dyes With Colors Other Than the Above Colors)

C.I. Direct Violet-47, C.I. Direct Violet-48, etc.; C.I. Direct Brown-109, C.I. Direct Green-59, etc.;

(Acid Black Dyes)

C.I. Acid Black (hereinafter referred to as “ABk”)-2, C.I.ABk-7, C.I.ABk-24, C.I.ABk-26, C.I.ABk-31, C.I.ABk-52, C.I.ABk-63, C.I.ABk-112, C.I.ABk-118, C.I.ABk-168, C.I.ABk-172, C.I.ABk-208, etc.;

(Acid Yellow Dyes)

C.I. Acid Yellow (hereinafter referred to as “AY”)-11, C.I.AY-17, C.I.AY-23, C.I.AY-25, C.I.AY-29, C.I.AY-42, C.I.AY-49, C.I.AY-61, C.I.AY-71, etc.;

(Acid Red Dyes)

C.I. Acid Red (hereinafter referred to as “AR”)-1, C.I.AR-6, C.I.AR-8, C.I.AR-32, C.I.AR-37, C.I.AR-51, C.I.AR-52, C.I.AR-80, C.I.AR-85, C.I.AR-87, C.I.AR-92, C.I.AR-94, C.I.AR-115, C.I.AR-180, C.I.AR-254, C.I.AR-256, C.I.AR-289, C.I.AR-315, C.I.AR-317 etc.;

(Acid Blue Dyes)

C.I. Acid Blue (hereinafter referred to as “AB”)-9, C.I.AB-22, C.I.AB-40, C.I.AB-59, C.I.AB-93, C.I.AB-102, C.I.AB-104, C.I.AB-113, C.I.AB-117, C.I.AB-120, C.I.AB-167, C.I.AB-229, C.I.AB-234, C.I.AB-254, etc.;

(Acid Dyes With Colors Other Than the Above Colors)

C.I. Acid Orange-7, C.I. Acid Orange-19, C.I. Acid Violet-49, etc.;

(Basic Black or Red Dyes)

C.I. Basic Black-2, etc.; C.I. Basic Red (hereinafter referred to as “BR”)-1, C.I.BR-2, C.I.BR-9, C.I.BR-12, C.I.BR-13, C.I.BR-14, C.I.BR-27, etc.;

(Basic Blue Dyes)

C.I. Basic Blue (hereinafter referred to as “BB”)-1, C.I.BB-3, C.I.BB-5, C.I.BB-7, C.I.BB-9, C.I.BB-24, C.I.BB-25, C.I.BB-26, C.I.BB-28, C.I.BB-29, etc.;

(Basic Dyes With Colors Other Than the Above Colors)

C.I. Basic Violet-7, C.I. Basic Violet-14, C.I. Basic Violet-27, etc.; C.I. Food Black-1, C.I. Food Black-2, etc.;

(Reactive Black Dyes)

C.I. Reactive Black (hereinafter referred to as “RBk”)-1, C.I.RBk-5, C.I.RBk-8, C.I.RBk-13, C.I.RBk-14, C.I.RBk-23, C.I.RBk-31, C.I.RBk-34, C.I.RBk-39, etc.;

(Reactive Yellow Dyes)

C.I. Reactive Yellow (hereinafter referred to as “RY”)-2, C.I.RY-3, C.I.RY-13, C.I.RY-15, C.I.RY-17, C.I.RY-18, C.I.RY-23, C.I.RY-24, C.I.RY-37, C.I.RY-42, C.I.RY-57, C.I.RY-58, C.I.RY-64, C.I.RY-75, C.I.RY-76, C.I.RY-77, C.I.RY-79, C.I.RY-81, C.I.RY-84, C.I.RY-85, C.I.RY-87, C.I.RY-88, C.I.RY-91, C.I.RY-92, C.I.RY-93, C.I.RY-95, C.I.RY-102, C.I.RY-111, C.I.RY-115, C.I.RY-116, C.I.RY-130, C.I.RY-131, C.I.RY-132, C.I.RY-133, C.I.RY-135, C.I.RY-137, C.I.RY-139, C.I.RY-140, C.I.RY-142, C.I.RY-143, C.I.RY-144, C.I.RY-145, C.I.RY-146, C.I.RY-147, C.I.RY-148, C.I.RY-151, C.I.RY-162, C.I.RY-163, etc.;

(Reactive Red Dyes)

C.I. Reactive Red (hereinafter referred to as “RR”)-3, C.I.RR-13, C.I.RR-16, C.I.RR-21, C.I.RR-22, C.I.RR-23, C.I.RR-24, C.I.RR-29, C.I.RR-31, C.I.RR-33, C.I.RR-35, C.I.RR-45, C.I.RR-49, C.I.RR-55, C.I.RR-63, C.I.RR-85, C.I.RR-106, C.I.RR-109, C.I.RR-111, C.I.RR-112, C.I.RR-113, C.I.RR-114, C.I.RR-118, C.I.RR-126, C.I.RR-128, C.I.RR-130, C.I.RR-131, C.I.RR-141, C.I.RR-151, C.I.RR-170, C.I.RR-171, C.I.RR-174, C.I.RR-176, C.I.RR-177, C.I.RR-183, C.I.RR-184, C.I.RR-186, C.I.RR-187, C.I.RR-188, C.I.RR-190, C.I.RR-193, C.I.RR-194, C.I.RR-195, C.I.RR-196, C.I.RR-200, C.I.RR-201, C.I.RR-202, C.I.RR-204, C.I.RR-206, C.I.RR-218, C.I.RR-221, etc.;

(Reactive Blue Dyes)

C.I. Reactive Blue (hereinafter referred to as “RB”)-2, C.I.RB-3, C.I.RB-5, C.I.RB-8, C.I.RB-10, C.I.RB-13, C.I.RB-14, C.I.RB-15, C.I.RB-18, C.I.RB-19, C.I.RB-21, C.I.RB-25, C.I.RB-27, C.I.RB-28, C.I.RB-38, C.I.RB-39, C.I.RB-40, C.I.RB-41, C.I.RB-49, C.I.RB-52, C.I.RB-63, C.I.RB-71, C.I.RB-72, C.I.RB-74, C.I.RB-75, C.I.RB-77, C.I.RB-78, C.I.RB-79, C.I.RB-89, C.I.RB-100, C.I.RB-101, C.I.RB-104, C.I.RB-105, C.I.RB-119, C.I.RB-122, C.I.RB-147, C.I.RB-158, C.I.RB-160, C.I.RB-162, C.I.RB-166, C.I.RB-169, C.I.RB-170, C.I.RB-171, C.I.RB-172, C.I.RB-173, C.I.RB-174, C.I.RB-176, C.I.RB-179, C.I.RB-184, C.I.RB-190, C.I.RB-191, C.I.RB-194, C.I.RB-195, C.I.RB-198, C.I.RB-204, C.I.RB-211, C.I.RB-216, C.I.RB-217, etc.;

(Reactive Orange Dyes)

C.I. Reactive Orange (hereinafter referred to as “RO”)-5, C.I.RO-7, C.I.RO-11, C.I.RO-12, C.I.RO-13, C.I.RO-15, C.I.RO-16, C.I.RO-35, C.I.RO-45, C.I.RO-46, C.I.RO-56, C.I.RO-62, C.I.RO-70, C.I.RO-72, C.I.RO-74, C.I.RO-82, C.I.RO-84, C.I.RO-87, C.I.RO-91, C.I.RO-92, C.I.RO-93, C.I.RO-95, C.I.RO-97, C.I.RO-99, etc.;

(Reactive Violet Dyes)

C.I. Reactive Violet (hereinafter referred to as “RV”)-1, C.I.RV-4, C.I.RV-5, C.I.RV-6, C.I.RV-22, C.I.RV-24, C.I.RV-33, C.I.RV-36, C.I.RV-38, etc.;

(Reactive Green Dyes)

C.I. Reactive Green (hereinafter referred to as “RG”)-5, C.I.RG-8, C.I.RG-12, C.I.RG-15, C.I.RG-19, C.I.RG-23, etc.;

(Reactive Brown Dyes)

C.I. Reactive Brown (hereinafter referred to as “RBr”)-2, C.I.RBr-7, C.I.RBr-8, C.I.RBr-9, C.I.RBr-11, C.I.RBr-16, C.I.RBr-17, C.I.RBr-18, C.I.RBr-21, C.I.RBr-24, C.I.RBr-26, C.I.RBr-31, C.I.RBr-32, C.I.RBr-33, etc.

The colorant may preferably account for 0.1 to 20 wt. % of the total weight of the ink, with 1 to 10 wt. % being more preferred. A proportion of the colorant smaller than 0.1 wt. % cannot provide printed images with any sufficient color density, while a proportion of the colorant greater than 20 wt. % invites a reduction in ejection stability such as clogging at nozzles although the color density does not increase substantially.

The water-based ink according to the present invention contains water as the principal liquid medium, but it may additionally contain one or more water-soluble organic media. When the ink according to the present invention is used in inkjet printers, these organic media serve to prevent solidification of the ink in nozzle portions due to its drying. Specific examples of these organic media include alcohols such as isopropanol and butanol; diols such as ethylene glycol, diethylene glycol, triethylene glycol, tetraethylene glycol, propylene glycol, dipropylene glycol, tripropylene glycol, 1,2-butanediol, 1,3-butanediol, 1,4-butanediol, thiodiglycol, neopentyl glycol, 1,4-cyclohexanediol and polyethylene glycol; alkylene glycol monoalkyl ethers such as ethylene glycol monomethyl ether, ethylene glycol monoethyl ether, ethylene glycol monoisoproyl ether, ethylene glycol monoallyl ether, diethylene glycol monomethyl ether, diethylene glycol monoethyl ether, diethylene glycol monobutyl ether, triethylene glycol monomethyl ether, triethylene glycol monoethyl ether, propylene glycol monomethyl ether and dipropylene glycol monomethyl ether; polyols such as glycerin, 1,2,4-butanetriol, 1,2,5-pentanetriol, 1,2,6-hexanetriol, trimethylolethane, trimethylolpropane and pentaerythritol; cyclic ethers such as tetrahydrofuran and dioxane; and dimethylsulfoxide, diacetone alcohol, glycerin monoallyl ether, N-methyl-2-pyrrolidone, 2-pyrrolidone, γ-butyrolactone, 1,3-dimethyl-2-imidazolidinone, sulfolane, urea, β-dihydroxyethylurea, acetonylacetone, dimethylformamide, dimethylacetamide and phenoxyethanol.

These organic media can be either solid or liquid insofar as they are soluble in water. As they are required to remain in inks even under such conditions that water evaporates, their boiling points are desirably higher than that of water, for example, 120° C. or higher. However, these organic media are not necessarily limited to high-boiling media, because they have an interaction with the block copolymer and become less volatile than when they are heated alone.

These organic media can be used either singly or in combination. These organic media may account for 5 to 50 wt. % of the total weight of the ink, with 10 to 30 wt. % being preferred. It is to be noted that in addition to the above-described components, a variety of additives, for example, such as surfactants, pH adjusters, antioxidants and antimolds can be added to the ink according to the present invention.

The ink according to the present invention can be produced by adding the colorant and block copolymer to a predetermined liquid medium and subjecting them to dispersion processing under application of ultrasonic waves or in a disperser such as a bead mill or ball mill.

The ink according to the present invention can be suitably used in the inkjet recording method that performs recording by applying energy to the ink to cause the ink to fly. As the energy, thermal energy or mechanical energy can be used. It is, however, particularly preferred to use thermal energy.

Illustrative inkjet recording printers in which the ink according to the present invention can be used include general domestic printers which primarily use A4-size paper, printers designed exclusively for the printing of business cards and other cards, and large printers for business use. The ink according to the present invention is particularly suited for use in large printers which are required to assure high image fastness and use a great deal of ink.

Examples of recording media on which recording can be performed with the ink according to the present invention include so-called plain paper without any special coating applied thereon, so-called inkjet paper with an ink-receiving layer coated on at least one side thereof, postcard or business card paper, label paper, corrugated paper boards, and inkjet films.

### EXAMPLES

A description will hereinafter be made about specific examples of the present invention. It is, however, to be noted that the present invention shall by no means be limited by the following examples. In the examples, all designations of “part” or “parts” and “%” are on a weight basis unless otherwise specifically indicated.

(1) Synthesis of an ABC Triblock Copolymer (Polymer 1)

A glass vessel fitted with a three-way cock was purged with nitrogen gas, and then, heated at 250° C. under a nitrogen gas atmosphere to remove any adsorbed water. After the system was allowed to cool down to room temperature, 1-isobutyl vinyl ether (12 mmol), ethyl acetate (16 mmol), 1-isobutoxyethyl acetate (0.1 mmol) and toluene (11 mL) were charged. When the internal temperature of the system had been chilled to 0° C., ethyl aluminum sesquichloride (0.2 mmol) was added to initiate polymerization, and A segments of a triblock copolymer were synthesized.

Using a gel permeation column chromatograph (GPC, “HLC-8220”, trade name; manufactured by TOSOH CORPORATION), the molecular weight was monitored in a time division manner. Subsequent to the completion of the polymerization of the A segments, 2-methoxyethyl vinyl ether (12 mmol) was added to conduct synthesis of B segments. After the completion of the polymerization of the B segments had been confirmed by monitoring the polymerization with GPC in a similar manner as described above, ethyl 4-(2-vinyloxyethoxy)benzoate (10 mmol) was added to conduct synthesis of C segments. Termination of the polymerization reaction was effected by adding into the system a 0.3% solution of ammonia in methanol.

Identification of the resultant triblock copolymer was conducted using a nuclear magnetic resonance spectrometer (NMR, “DPX 400”, trade name; manufactured by Bruker BioSpin Corp.) and GPC. Both of the analyses resulted in the indication of satisfactory synthesis of the target substance. The number average molecular weight (Mn) of the thus-obtained triblock copolymer was 30,000 in terms of an estimate based on the standard polystyrene calibration, while its weight average molecular weight (Mw)/number average molecular weight (Mn) ratio (Mw/Mn), which indicates the degree of its molecular distribution, was 1.3.

Ester portions in the C segments in the triblock copolymer were hydrolyzed in a mixed solvent of sodium hydroxide (5-fold equivalents) and methanol, and the solvent was then distilled off to obtain a carboxylic acid polymer.

(2) Synthesis of an AB Diblock Copolymer (Polymer 2)

A glass vessel fitted with a three-way cock was purged with nitrogen gas, and then, heated at 250° C. under a nitrogen gas atmosphere to remove any adsorbed water. After the system was allowed to cool down to room temperature, 1-isobutyl vinyl ether (12 mmol), ethyl acetate (16 mmol), 1-isobutoxyethyl acetate (0.1 mmol) and toluene (11 mL) were charged. When the internal temperature of the system had been chilled to 0° C., ethyl aluminum sesquichloride (0.2 mmol) was added to initiate polymerization, and A segments of a diblock copolymer were synthesized.

Using the gel permeation column chromatograph (GPC, “HLC-8220”, trade name; manufactured by TOSOH CORPORATION) , the molecular weight of the A segments was monitored in a time division manner. Subsequent to the completion of the polymerization of the A segments, 2-(ethoxycarbonyl)ethyl vinyl ether (10 mmol) was added to conduct synthesis of B segments. Termination of the polymerization reaction was effected by adding into the system a 0.3% solution of ammonia in methanol. Identification of the resultant diblock copolymer was conducted using the nuclear magnetic resonance spectrometer (NMR, “DPX 400”, trade name; manufactured by Bruker BioSpin Corp.) and GPC. Both of the analyses resulted in the indication of satisfactory synthesis of the target substance. The number average molecular weight (Mn) of the thus-obtained diblock copolymer was 25,000 in terms of an estimate based on the standard polystyrene calibration, while its weight average molecular weight (Mw)/number average molecular weight (Mn) ratio (Mw/Mn), which indicates the degree of its molecular distribution, was 1.3.

Ester portions in the B segments in the diblock copolymer were hydrolyzed in a mixed solvent of sodium hydroxide (5-fold equivalents) and methanol, and the solvent was then distilled off to obtain a carboxylic acid polymer.

(3) Measurements of Neutralization Degrees of the Block Copolymers

The two block copolymers were each separately dissolved at 2% concentration in tetrahydrofuran. Subsequent to addition of an aqueous solution of sodium hydroxide, a single droplet of each solution was placed on a single-crystal plate of calcium fluoride and then dried, and its infrared absorption spectrum was measured by an infrared absorption spectrometer (“FT/IR5300”, trade name; manufactured by JASCO Corporation). On each of the two block copolymers, an absorption ascribable to carboxyl ions was observed at 1,547 cm⁻¹.

A comparison in the infrared absorption intensities ascribable to carboxyl ions between the two block copolymers was conducted based on their relative intensities determined by using as a standard the intensity of an infrared absorption ascribable to ether groups at 1,119 cm⁻¹. Further, supposing that the relative infrared absorption intensity ascribable to carboxyl ions upon complete neutralization was 100%, the relative infrared absorption intensity ascribable to carboxyl ions in each sample to the first-mentioned relative infrared absorption intensity was defined as the degree of neutralization of the sample.

(4) Preparation of Inks

The water-based inks shown in Table 1 was each prepared by neutralizing the corresponding triblock copolymer or diblock copolymer (1 part) with a 0.1 N aqueous solution of sodium hydroxide, adding the thus-neutralized copolymer together with the corresponding colorant (1 part) to N,N-dimethylformamide (19 parts), adding water to the resultant mixture such that the amount of water became 20 parts in combination with the water in the aqueous solution of sodium hydroxide, eliminating N,N-dimethylformamide by a rotary evaporator, and then adding diethylene glycol (2 parts) and glycerin (2 parts).

TABLE 1

| | | | Amount of | Degree of |
|---|---|---|---|---|
| | | | the | neutrali- |
| | Polymer | Colorant | alkali* | zation (%) |
| Ink 1 | 1 | C.I. Solvent Blue 44 | 0.5 | 80 |
| Ink 2 | 1 | C.I. Solvent Blue 44 | 1 | 100 |
| Ink 3 | 1 | C.I. Solvent Blue 44 | 1.25 | 100 |
| Ink 4 | 1 | C.I. Solvent Blue 44 | 1.5 | 100 |
| Ink 5 | 1 | C.I. Solvent Blue 44 | 2 | 100 |
| Ink 6 | 1 | C.I. Solvent Yellow 21 | 0.5 | 80 |
| Ink 7 | 1 | C.I. Solvent Yellow 21 | 1 | 100 |
| Ink 8 | 1 | C.I. Solvent Yellow 21 | 1.25 | 100 |
| Ink 9 | 1 | C.I. Solvent Yellow 21 | 2 | 100 |
| Ink 10 | 1 | Carbon Black MA8 | 0.5 | 80 |
| Ink 11 | 1 | Carbon Black MA8 | 1 | 100 |
| Ink 12 | 1 | Carbon Black MA8 | 1.25 | 100 |
| Ink 13 | 1 | Carbon Black MA8 | 2 | 100 |
| Ink 14 | 2 | C.I. Solvent Blue 44 | 0.5 | 80 |
| Ink 15 | 1 | C.I. Solvent Blue 44 | 0.25 | 65 |
| Ink 16 | 1 | C.I. Solvent Blue 44 | 2.25 | 100 |
| Ink 17 | 1 | C.I. Solvent Blue 44 | 2.5 | 100 |
| Ink 18 | 1 | C.I. Solvent Yellow 21 | 0.25 | 65 |
| Ink 19 | 1 | C.I. Solvent Yellow 21 | 2.5 | 100 |
| Ink 20 | 1 | Carbon Black MA8 | 0.25 | 65 |
| Ink 21 | 1 | Carbon Black MA8 | 0.125 | 30 |
| Ink 22 | 1 | Carbon Black MA8 | 2.25 | 100 |
| Ink 23 | 1 | Carbon Black MA8 | 2.5 | 100 |
| Ink 24 | 2 | C.I. Solvent Blue 44 | 0.33 | 70 |
| Ink 25 | 2 | C.I. Solvent Blue 44 | 2.5 | 100 |

*Amount of the alkali actually added as expressed supposing that the smallest amount of the alkali required to achieve a neutralization degree of 100% was 1.

(Ranking)

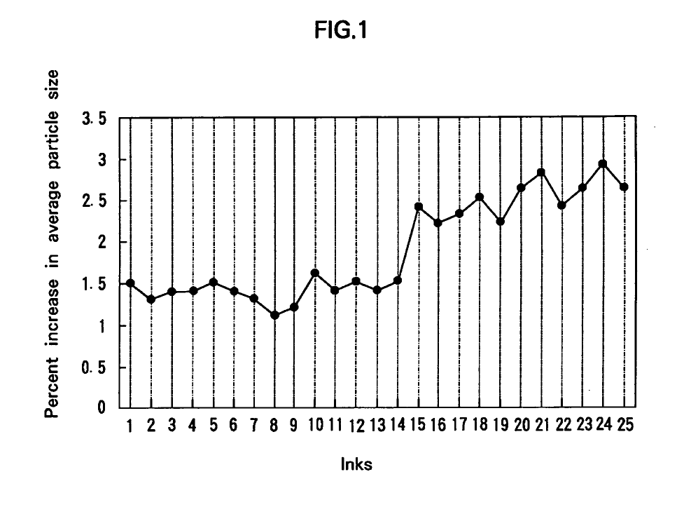

The water-based inks 1-25 shown in Table 1 were left at rest at 60° C. for 4 weeks, and the particle sizes of their colorants were measured by the dynamic light scattering method. As a result, it is appreciated that as illustrated in FIG. 1, an ink making use of a vinyl ether block copolymer has high dispersion stability and permits more stable dispersion especially when the degree of neutralization of the block copolymer and the amount of an added alkali fall within their corresponding ranges specified in the present invention.

### INDUSTRIAL APPLICABILITY

As appreciated from the foregoing description, the present invention can provide a water-based ink for inkjet printers, which is of the colorant particle dispersion type, is excellent in storage stability, and provides prints of high image fastness such as waterproofness, light fastness and gas resistance.

1. A water-based ink for inkjet printers, said water-based ink comprising at least a water-insoluble colorant, a block copolymer of a polyvinyl ether structure comprising at least one kind of hydrophilic segments each of which contains acidic groups and at least one kind of hydrophobic segments, water and an alkali, characterized in that a content of said alkali is such that, when an infrared absorption intensity ascribable to ionic groups to be formed upon addition of an excess amount of said alkali to said block copolymer is supposed to be 100%, an infrared absorption intensity ascribable to ionic groups formed by dissociation of said acidic groups contained in said block copolymer becomes at least 80%, with a proviso that said content does not exceed twice as much as a smallest amount of said alkali that an infrared absorption ionic groups to be formed from said block copolymer becomes 100%.

2. A water-based ink according to claim 1, wherein said acidic groups contained in said block copolymer are carboxyl 20 groups.

3. A water-based ink according to claim 1, wherein said colorant is a pigment.

4. A water-based ink according to claim 1, wherein said colorant is a water-insoluble dye.

5. A water-based ink according to claim 2, wherein said colorant is a pigment.

6. A water-based ink according to claim 2, wherein said colorant is a water-insoluble dye.
